(19) United States
(12) Patent Application Publication
(10) Pub. No.: US 2007/0050102 A1
(43) Pub. Date: Mar. 1, 2007

(54) Space based navigation system

(76) Inventors: Gary Neil Johnson, San Pedro, CA (US); Warren W. James, South Pasadena, CA (US); Stuart Michael Feldman, Huntington Beach, CA (US)

Correspondence Address: LOUIS L. DACHS, 1794 PALISADES DRIVE, PACIFIC PALISADES, CA, 90272, US

(21) Appl. No.: 11/214,258

(22) Filed: Aug. 29, 2005

(51) Int. Cl. B64G 1/36

(52) U.S. Cl. 701/13; 701/226

(57) ABSTRACT

The invention is a spaced based navigation system for guiding a spacecraft. In detail, the navigation system includes at least two Doppler range/range rate satellites positioned at LaGrangian stability points between first and second planetary bodies wherein the first planetary body rotates about the second planetary body. A processing system mounted on the spacecraft for receiving Doppler range and range rate data from said at least two Doppler range/range rate satellites and calculating the position and velocity of the spacecraft.

### BACKGROUND OF THE INVENTION

1. Field of the Invention

The invention relates to the field of navigation systems for use of spacecraft and, in particular, to space based system that allows a spacecraft to navigate independently of earth based control.

2. Description of Related Art

In order to support exploration to the moon and especially beyond with a maximum of autonomy, a great advantage could be obtained by creating a system to support accurate on-board state vector generation. This would allow for mission planning, maneuver generation, on-board navigation instrument calibration and drift offsetting, orbital insertion planning, as well as a near continuous accurate knowledge of the spacecraft's position and velocity to be performed without the need of ground support.

The current method of maintaining the on-board state vector for lunar and interplanetary craft is to ground generate this knowledge, and uplink it periodically. Maneuver planning and all other major events which depend on the position and velocity of the craft are also ground generated. This method has a proven track record, but as one travels farther from the earth, an accurate and timely on-board system that can perform this function either automatically or via crew commanding becomes highly advantageous.

State vector accuracies as generated by any measuring system diminish over distance. This lead to an initial assumption that the best method to maintain measured accuracies capable of supporting space operations requires a system that can either be effectively expanded or transported as planetary exploration expands. Two possibilities accommodate this assumption: a navigation system based on the spacecraft itself, or a space based system accessible to the spacecraft.

For space based assets, highly accurate positional knowledge of the measuring systems is necessary since any offset would propagate as an offset to the origin of the measurement coordinate system. Three body gravitationally stable orbits are well defined, and reduce or eliminate outside perturbations that would require periodic regeneration of on-board ephemeredes to account for the orbital instability of a measurement reference satellite. Furthermore, for on-board based assets, the required equipment must either be currently available on interplanetary spacecraft, or their addition does not impact power, weight, or any other physical requirements of the craft.

GPS navigational systems rely on triangulation, which in turn relies on separation angle of the observation/transmission points. At lunar distances, the maximum angular separation of GPS satellites for triangulation is 1 degree. At Martian distances this shrinks to an angular separation range of 7 to 36 arc seconds. Furthermore, velocity determination for GPS is relative to the satellite's Line-Of-Sight. Anything at lunar orbit distances would not allow for accurate velocity angular calculations, making this system unreliable for both position and velocity determination for missions to the moon or beyond.

Thus, it is a primary object of the invention to provide a spaced based navigation system for spacecraft.

It is another primary object of the invention to provide a spaced based navigation system for spacecraft that is independent of earth.

It is a further object of the invention to provide it is another primary object of the invention to provide a spaced based navigation system for spacecraft that is independent of earth and which makes use of strategically positioned satellites.

### SUMMARY OF THE INVENTION

The invention is a spaced based navigation system for guiding a spacecraft. In detail, the navigation system includes at least two Doppler range/range rate satellites positioned at LaGrangian stability points between first and second planetary bodies wherein the first planetary body rotates about the second planetary body. A processing system mounted on the spacecraft for receiving Doppler range and range rate data from said at least two Doppler range/range rate satellites and calculating the position and velocity of the spacecraft.

The first planetary body can be the moon and the second planetary body the earth. The preferred LaGrangian stability points are L4 and L5. If the first planetary body can be a planet, such as Mars circulating the sun and the second planetary body is the sun and the LaGrangian stability points are L1 and L5.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a schematic of the LaGrangian points for two planetary bodies wherein one rotates about the other.

FIG. 2 is a schematic of the Earth-Moon L4, L5 Lunar Transition Geometry.

FIG. 3 is a display of the line of sight velocity profiles.

FIG. 4 is a pictorial representation of the infinite number of possibilities for the Vector component A.

FIG. 5 is a pictorial representation of the infinite number of possibilities for the Vector component B.

FIG. 6 is pictorial representation of the combining of the Vector A and B components when one of the satellites has a relative velocity equal to zero.

FIGS. 7A, 7B and 7C are schematics of the Mars-Sun L4, L5 Lunar Transition Geometry during various stages of a spacecraft flight to Mars.

FIG. 8 is a schematic of the system that the spacecraft will require in order to use the LaGrangian satellites for navigation.

### DESCRIPTION OF THE PREFERRED EMBODIMENT

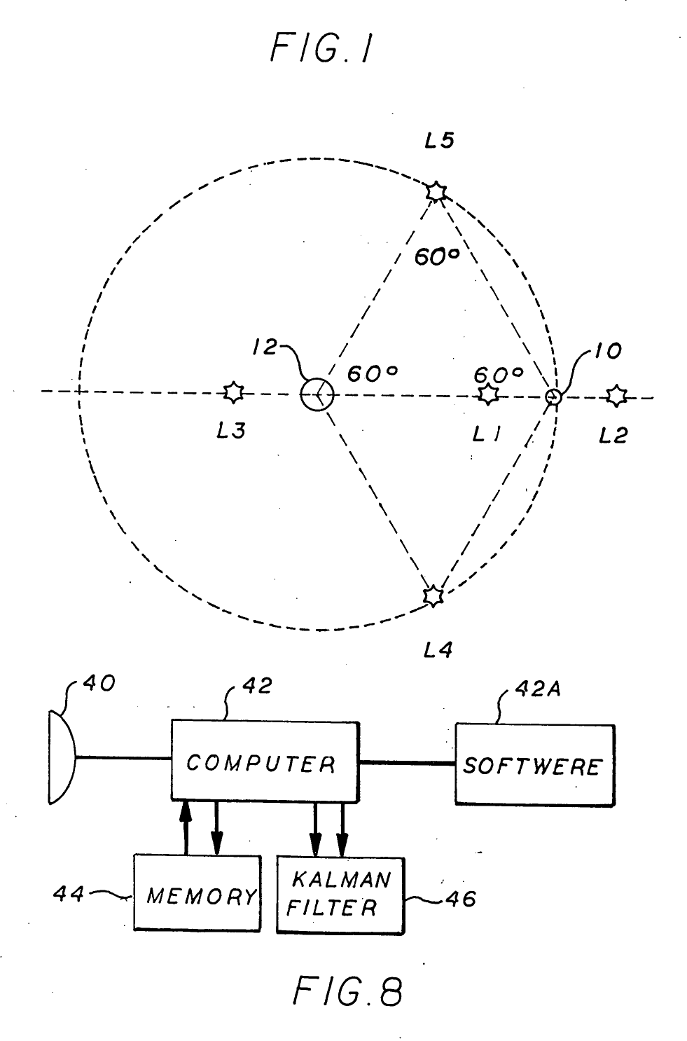

It is well established that in any planetary system wherein a moon circulates about a planet or a planet circulates about the sun, LaGrangian points exists. LaGrangian points are locations between the two planetary bodies where the effect of the gravitational pull of each planet is balanced. Referring to FIG. 1, a first body, for example a moon, indicated by numeral 10, is shown orbiting a second body, for example a planet 12. Since the planet 12 is larger than the moon 10, its gravity is greater. Thus the points are indicated for LaGrangian positions L1, L2, L3, L4, and L5. Any satellite located at these points would require minimum station keep efforts. It should be noted that LaGrangian points exist about a planet circulating about the sun. Of particular interest are positions L4 and L5 having the added attribute of being on an orbital period to maintain that gravitationally stable point.

State vectors can be determined only through triangulation. In order to triangulate, you need to observe, or be observed by three known non-planar points. The accuracy of the state vector is determined by the accuracy of the knowledge of the spatial position of the points and the accuracy of measuring their relative position to the target.

Doppler range/range rate measuring navigation systems have been used for many years, and have a proven record for accuracy and dependability. Studies of several configurations of orbital Doppler systems have lead to the conclusion that by placing two Doppler satellites in combinations of Earth-Sun, Mars-Sun, Venus-Sun, and Earth-Moon L1-L5 points results in highly accurate planar position and instantaneous velocity determination using on-board navigation determination. A pair of sun polar satellites at Earth orbital distance (with an orbital separation of 90 degrees to insure one is always out of plane) completes the necessary configuration for triangulation by supplying the out-of-plane component.

Triangulation and velocity accuracies are dependent on the Doppler signal uncertainties only, since the angular separation of the observed transmissions if at least 120 degrees (2 times the angular separation from the target planet to its associated L4 and L5 LaGrangian points, which is always 60 degrees). Therefore, transmission requirements for the satellites occupying the L4 and L5 points need only be a periodic, time tagged, Doppler signal to cover all navigational requirements for Earth orbiting or interplanetary space vehicles by using the coordinate transformation and range triangulation methods described in this paper. Any satellite with an accurate on-board clock could then determine its state vector even without any previous position/velocity knowledge (on-board processor failure or reset).

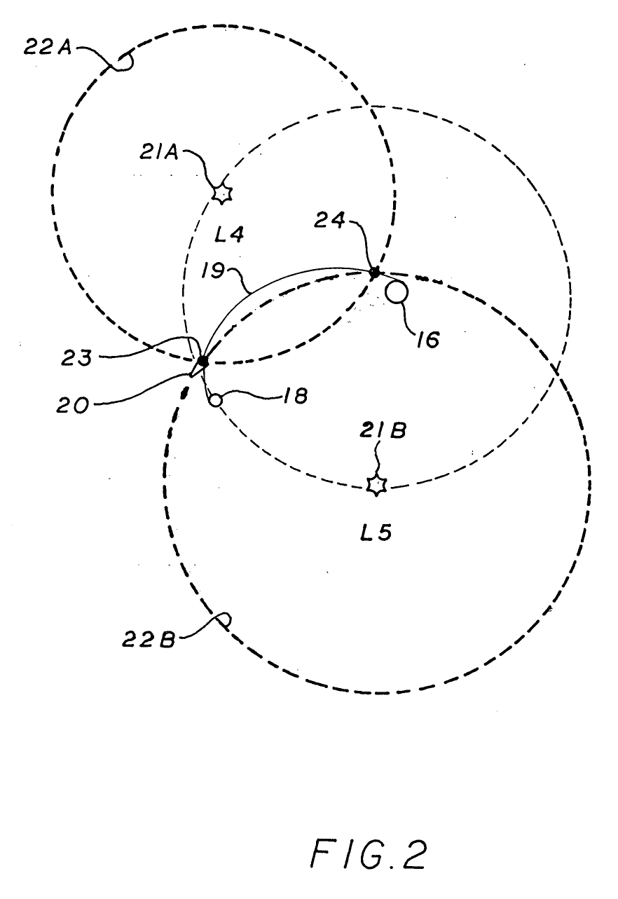

Referring to FIG. 2, the first concept was to look at placing two Doppler range/range rate satellites into the Earth-Moon L4 and L5 points and determining if the geometry was amenable for lunar missions. The earth 16 and moon 18 in orbit there around with a track 19 of a spacecraft 20 there between. The satellite 21A at the L4 position and satellite 21B at the L5 position send out signals in circular patterns, indicated by dotted circles 22A and 22B. These points are not only gravitationally stable, but being at lunar distances from the Earth they avoid the Low Earth Orbit (LEO) and Middle Earth Orbit (MEO) J2 and J22 nodal regression problems. These are gravitational perturbation influences on earth orbiting satellites due to the Earth having a wider equatorial radius than polar radius (J2 effect), and that the Earth's southern hemisphere has more mass, and therefore more gravitational pull than the northern hemisphere (J22 effect). These non-homogenous distributions of Earth's mass have an inverse square effect on satellite orbits in relation to their orbital distances, making lunar orbit distances in a gravity stable point (L4 or L5) undisturbed.

This configuration would require minimal station keeping maneuvers, and what maneuvers are required would be small, allowing for efficient fuel systems such as Xenon Ion Propulsion further extending the life of the satellites. The geometry gives a two possibility planar solutions at the two intersecting points 23 and 24 of the circular patterns 22A and 22B. The solution could be easily reduced to one through comparing the results to the propagated state. Incorporation of a third sun polar beacon satellite's data would reduce the two possible solutions from the L4 and L5 satellite beacons to one answer (the intersection of the three range circles) for those craft with no previous state to propagate. This occurs when the satellite attempting to ascertain its position has lost all historical data due to an on-board processor failure or any other failure requiring the satellite to switch to a back-up processor

Other advantages to this initial Earth-Moon L4, L5, configuration is that it maintains a continuous line-of-sight orientation to ⅚^{th} of the lunar surface including all of the Earth facing side. This would supply an ideal communications relay system, which could be added to the satellite's capabilities easily. Other secondary payloads could include expanded communication capabilities, or science packages. An available bonus is that the Doppler signal emitted by these satellites would need to carry a high accuracy time tag, which could be used not only by Lunar or interplanetary craft, but also Earth orbiting space systems for internal clock updating (the addition of the Doppler Satellite's ephemeris to a satellite would allow for the travel time correction).

The amount of packages added to the satellite will determine the overall power consumption, but for Doppler range/range rate activities alone, an inexpensive “spinner” should be able to supply the necessary support, but no definitive study has been performed in this area. If used for lunar surface component and crew navigation, a three axis stable system might be required depending on the method of surface position determination.

Velocity can easily be calculated following position determination. Doppler velocity measurements are relative to line-of-sight rates. But by establishing a point of origin for the spacecraft through position triangulation, coordinate transformation of the observed rates into the spacecrafts coordinate reference allows for easy calculations. Below is a two dimensional demonstration.

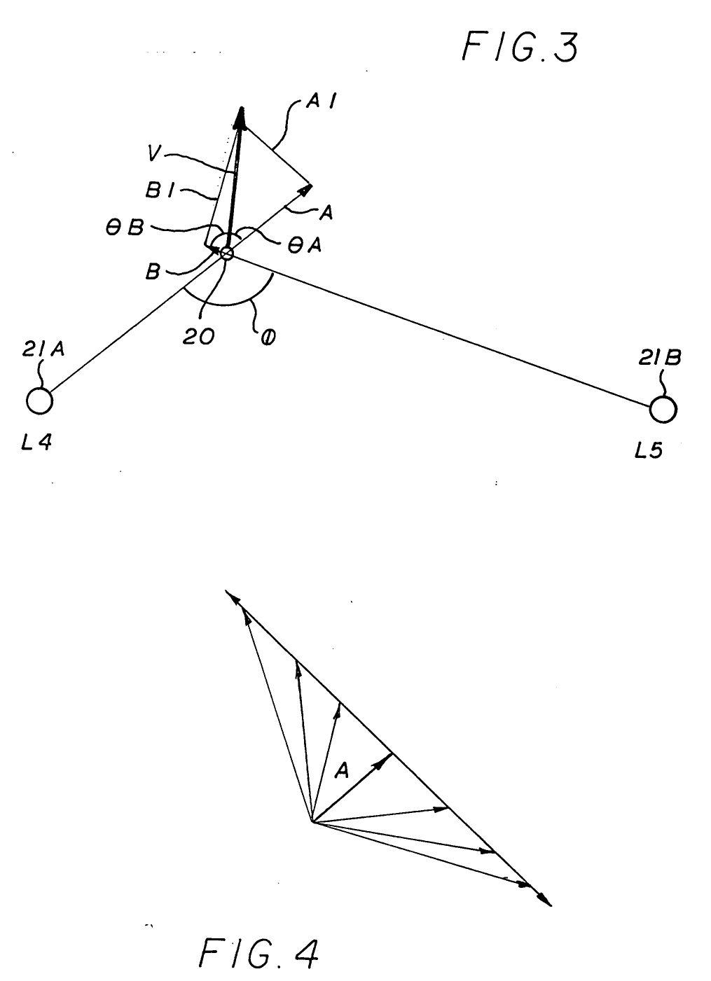

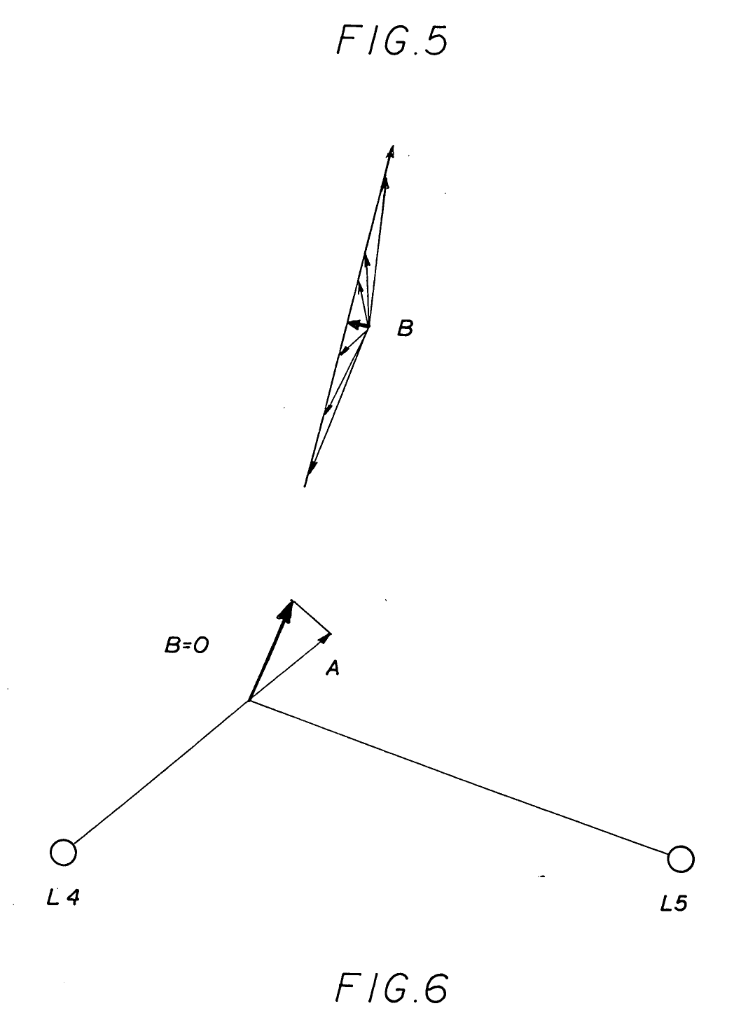

First, we look at a random geometry of two Doppler satellites and a target. Each satellite determines its relative line-of-sight (LOS) velocity, which can be trigonometrically associated with the true velocity as shown in the FIG. 3. A and B are the resulting velocity vector components, but since they do not share a common coordinate system, they can not be additively combined to find the true velocity. By breaking each component down, and adjusting the coordinate system to originate relative to the observed vector, it can be shown that each of the observed LOS vectors is one leg of a right triangle, and that the true velocity is the hypotenuse of this triangle. The true velocity vector must therefore terminate along the perpendicular to the observed vector, which for each observed LOS velocity vector (A and B) yields an infinite number of possible true velocities (See FIGS. 4 and 5) FIG. 3:

Still referring to FIGS. 2 and 3, to determine which of these infinite possibilities is the true velocity vector, we need to consider the relative LOS velocities in the target coordinate frame. Only one of the infinite number of answers available will exist as a possible answer to both the A and B LOS observations. Using the fact that the true velocity vector terminates on the orthogonal to both the A and B LOS observed velocities, there will be only one point in a common coordinate frame where these orthogonals intersect, defining the magnitude and direction of the True Velocity vector.

By placing the observed velocities and their respective orthogonals into the target centered coordinate system, you effectively take two sets of infinite possibilities and reduce them to one. The origin is the origin of the measured velocities, and the true velocity terminates at the intersection of the orthogonals. The true velocity vector magnitude and direction is now a simple trigonometric calculation.

Mathematically, the direction of the True Velocity vector V can be represented by the following equation:
(B*Tan(φ−θ_{A}))²=A²−B²+(A*Tan θ_{A})², with ⊖_{A} being the only variable
Where:
A=Relative velocity along L4 line of sight
B=Relative velocity along L5 line of sight
φ=is angle between A and B and is known
⊖_{A}=. Is the angle between true velocity vector and B
The True Velocity vector V magnitude equals A*cos⊖_{A}.
Note that:
φ=θ_{A}+θ_{B} Opposite angles of two intersecting lines.
V²=A²+A1² Pathagorian's theorem.
V²=B²+B1² Pathagorian's theorem.
Set the two V equations equal to each other:
B²+B1²=A²+A1² Rearranging to isolate the B1:
B1²=A²+A1²−B²

$$Tan {θ}_{a} = \frac{A 1}{A}$$

Trigonometric definition of tangent.
Rearrange to isolate the A1:
A*Tan θₐ=A1

$$Tan {θ}_{B} = \frac{B 1}{B}$$

Trigonometric definition of tangent.
Rearrange to isolate the B1:
B*Tan θ_{B}=B1
Substitute for Theta B from the first equation:
B1=B*Tan(φ−θ_{A})
Set the two B1 equations equal to each other:
B1²=A²−B²+(A*Tan θ_{A})²
Thus it is a very simple calculation to determine the velocity vector.

Since Doppler signal only measure relative LOS speed (the component either away or toward the beacon satellite). A singularity occurs when the target's True velocity is perpendicular to the satellite-target LOS, making the observed velocity vector zero, and therefore all directions equally acceptable as the observed velocity's orthogonal (all lines passing through a point are orthogonal to that point), and eliminating any possible True Velocity terminus which depends on identifying the orthogonal to the observed velocity vector. Since this only occurs when the true velocity is orthogonal to the satellite-target LOS, any singularities can be avoided by placing a limit restriction in the calculation software that establishes the observed velocity orthogonal as the perpendicular to the satellite-target LOS for observed velocities approaching zero (See FIG. 6). The same coordinate transformation and combination used before, along with the above definition that a zero relative velocity means all velocity is perpendicular to the line-of-sight.

The calculation for the velocity's third dimension does the same coordinate transformation method using the velocity vector determined in the two dimensional plane as a single velocity vector in its plane of reference, and identifying the orthogonal intersection between the two plane calculated velocity vector, and the out-of-plane observed velocity vector supplied by the sun polar beacons described earlier. This is then a repeat of the previous calculation.

For missions beyond the moon, this system of satellites can be expanded to include Mars-Sun or Earth-Sun LaGrangian points while still utilizing the previous Earth-Moon satellites. The two sun polar satellites, as described earlier, do not need to be expanded upon with additional satellites, and can cover all solar system navigation requirements (making operational lifetime a bigger driver for these. This would allow for long term science data collection and various other long term secondary packages).

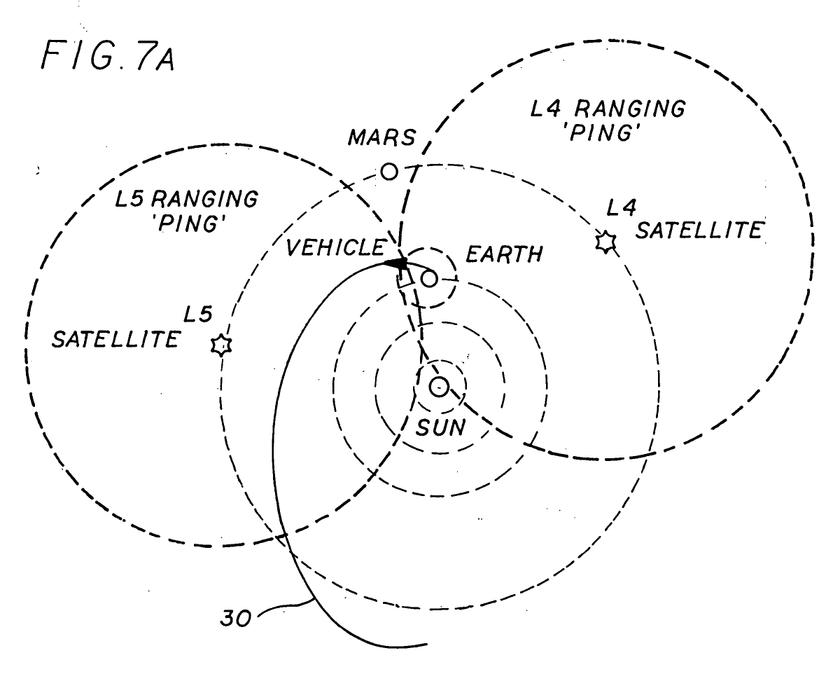

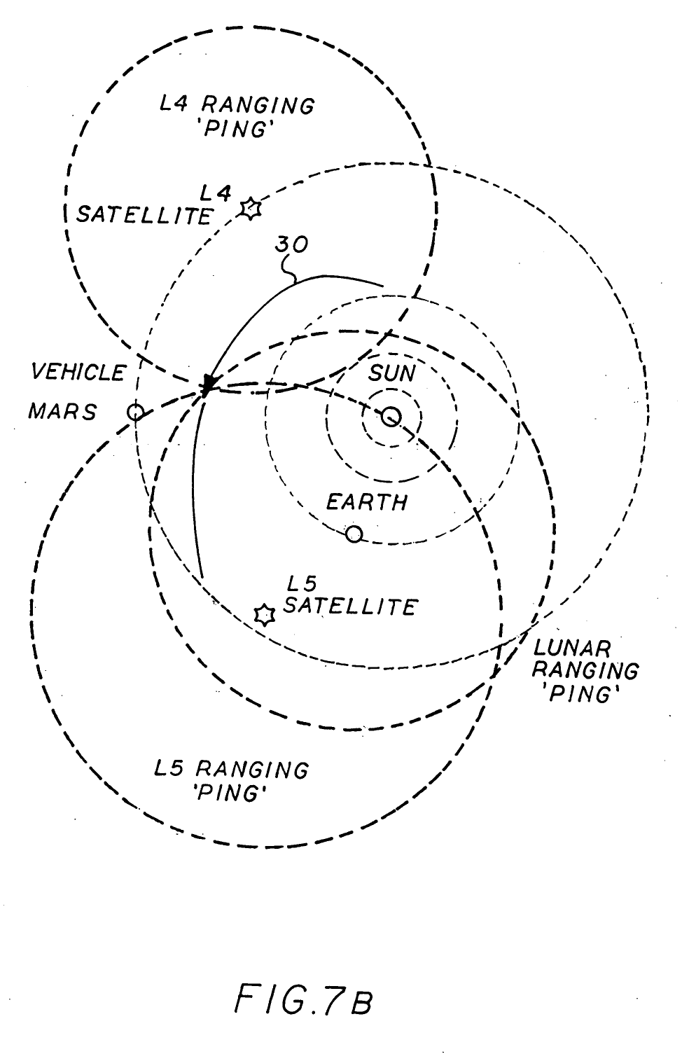

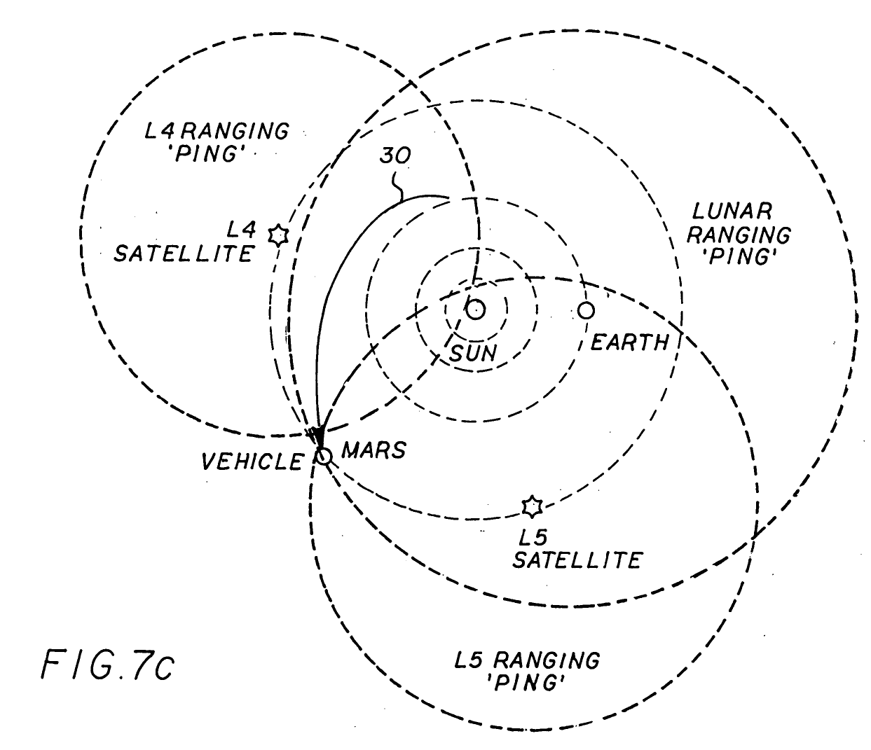

The following FIGS. 7A, 7B and 7C, show a rough Earth to Mars mission with the spacecraft trajectory indicated by numeral 30, demonstrating the geometries of the in plane portion of this navigational system (keeping in mind the out-of-plane portion never changes regardless of the mission). The figures show a beginning, midway, and end geometries using two Mars-Sun L4, L5 Doppler satellites, and the already existing Earth-Moon Doppler satellites.

With the Moon, the Mars satellites have line-of-sight access to ⅚^{th} of the Martian surface. Unlike the Moon, Mars rotates, giving a loss of signal duration of 4.1 hours every Martian day (1.026 Earth days) to any point on the surface, but they do have daily visibility of the entire Martian surface. This system can be used for future missions beyond Mars in the same manner the Earth-Moon satellites can be used for a Mars mission. These satellites would require greater power generation capabilities, but would also be available to support communications, and science packages. FIG. 9 illustrates a system using both a L4 and L5 satellites in Mars-Sun LaGrangian points as well as earths moon.

Given the following proposed hardware and software, any spacecraft, including earth orbiting satellites, could use this navigation system to perform autonomous state vector generation, internal clock updating, and maneuver planning as illustrated in FIG. 8:

1. An antenna 40 and associated hardware capable of receiving and de-commutating the Doppler satellites' transmission frequencies and data packets.

2. A computer 42 with software programs 42A that performs the above described position triangulation and velocity determination functions and an orbit targeting program to calculate delta velocity vectors and times for maneuver planning.

3. Dedicated memory 44 spaces to record previous state vectors.

4. A Kalman filtering program 46 to converge state vector accuracies, and perform sanity checks on internal state vector calculations.

The hardware and software already exists on most spacecraft. The necessary software algorithms, memory, and processing could be easily added to existing spacecraft processors, or developed as a stand alone unit that interfaces with the spacecraft processors.

A system of satellites using three body gravity stable orbits transmit a periodic signal that provides the necessary information to perform anytime autonomous on-board state vector calculations, internal clock updating, and communications relay for any spacecraft. This in turn would allow delta velocity maneuvers to be planned on-board, giving a much greater degree of flexibility, and the capability of recovering quickly from a missed or partially performed maneuver by not requiring time consuming ground calculations and transmittal delays which can take up to 21 minutes each way at Martian distances. This system would also allow instantaneous feedback of a maneuver's performance, and the capability of performing course corrections at any time.

This system could also maintain various secondary payloads, as well as provide communications links to the planet surface. The system would naturally expand as the realm of spaceflight expanded, yet still utilize the components put in place earlier resulting in high reusability.

While the invention has been described with reference to a particular embodiment, it should be understood that the embodiment is merely illustrative as there are numerous variations and modifications, which may be made by those skilled in the art. Thus, the invention is to be construed as being limited only by the spirit and scope of the appended claims.

### INDUSTRIAL APPLICABILITY

The invention has applicability to spacecraft manufacturing industry.

1. A spaced based navigation system for guiding a spacecraft, the navigation system comprising:
two Doppler range/range rate satellites positioned at LaGrangian stability points between first and second planetary bodies wherein the first planetary body rotates about the second planetary body; and
processing means mounted on the spacecraft for receiving Doppler range and range rate data from said at least two Doppler range/range rate satellites and calculating the position and velocity of the spacecraft.

2. The navigation system as set forth in claim 1 wherein said first planetary body is the moon and said second planetary body is the earth.

3. The navigation system as set forth in claim 2 wherein the LaGrangian stability points are L1 and L5.

4. The navigation system as set forth in claim 1 where in said first planetary body is a planet circulating the sun and the second planetary body is the sun.

5. The navigation system as set forth in claim 4 wherein the LaGrangian stability points are L4 and L5.

6. A spaced based navigation system for guiding a spacecraft, the navigation system wherein a first planetary body rotates about a second planetary body, the system comprising:
at least two Doppler range/range rate satellites positioned at LaGrangian stability points between the first and second planetary bodies wherein; and
processing means mounted on the spacecraft for receiving Doppler range and range rate data from said at least two doppler range/range rate satellites and calculating the position and velocity of the spacecraft.

7. The navigation system as set forth in claim 6 wherein the first planetary body is the moon and the second planetary body is the earth and said LaGrangian stability points are L1 and L5.

8. The navigation system as set forth in claim 7 where in the first planetary body is a planet circulating the sun and the second planetary body is the sun and said LaGrangian stability points are L4 and L5.
